(19) United States
(12) Patent Application Publication
(10) Pub. No.: US 2007/0062917 A1
(43) Pub. Date: Mar. 22, 2007

(54) Laser cutting and sawing method and apparatus

(75) Inventors: Qiang Fu, Baxter, MN (US); Joel Cardoso, Bandra Mumbai (IN)

Correspondence Address: DARBY & DARBY P.C., P. O. BOX 5257, NEW YORK, NY, 10150-5257, US

(73) Assignee: Quantronix Corporation, East Setauket, NY (US)

(21) Appl. No.: 11/290,208

(22) Filed: Nov. 30, 2005

Related U.S. Application Data
(60) Provisional application No. 60/719,532, filed on Sep. 21, 2005.

(51) Int. Cl. B23K 26/38; B23K 26/06

(52) U.S. Cl. 219/121.67; 219/121.73

(57) ABSTRACT

Laser cutting and sawing can be performed on a variety of materials, transparent or non-transparent, including quartz, sapphire, glass, semiconductors, and diamonds. By direct generation of a special laser beam from a laser cavity and/or by shaping of a laser beam, unique characteristics of the beam in X- and Y-axes are utilized in the cutting and sawing of materials. Such a method and apparatus can reduce breakage and weight loss of the processed material while maintaining or increasing the cutting/sawing throughput.

### CROSS-REFERENCE TO RELATED APPLICATIONS

This application claims the benefit under 35 USC 119(e) of U.S. Provisional Patent Application No. 60/719,532, filed on Sep. 21, 2005, which provisional application is incorporated herein by reference in its entirety.

### BACKGROUND OF THE INVENTION

Lasers have been used in diamond industry extensively especially for sawing diamonds. Laser sawing offers many advantages over other methods due to its small beam diameter, high average power, high energy and peak power, wide selection of laser wavelengths, as well as minimal maintenance and tool replacement. However, the state-of-the-art result from laser sawing is still about 0.3% breakage and 1% weight loss. As any other process, yield management is one of the most important aspects of the diamond sawing process. Any improvement on yield will have a tremendous impact both economically and technologically.

There have been some developments on diamond process improvement, such as, laser assisted polishing of diamond platelets; metallic coated diamond cutting; laser cutting of diamonds with polished surface; laser kerfing of diamonds; and laser marking of diamond surfaces. These techniques, however, do not typically address the yield issues in cutting diamonds. Breakage and weight loss remain some of the most costly issues for the industry.

### BRIEF SUMMARY

One embodiment is a laser cutting system that includes a laser configured and arranged to produce a laser beam and a beam modifying module disposed to receive the laser beam and generate a modified laser beam at a focal point. The modified laser beam has substantially larger divergence in a first direction than in a second orthogonal direction.

Another embodiment is a laser cutting system that includes a laser cavity configured and arranged to produce a laser beam with a TEM₀₀ beam profile along a first direction and a low-order or multi-mode profile along a second orthogonal direction.

Yet another embodiment is a method of cutting an object using a laser. The method includes generating a laser beam and directing the laser beam onto the object. At a site of cutting, the laser beam has substantially larger divergence in a first direction than in a second orthogonal direction.

A further embodiment is a method of cutting an object using a laser. The method includes generating a laser beam in a laser cavity. The laser beam has a TEM₀₀ beam profile along a first direction and a low-order or multi-mode profile along a second orthogonal direction. The laser beam is then directed onto the object.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic block diagram showing one example of an apparatus for diamond sawing, according to the invention;

FIG. 2 is a schematic perspective view illustrating beam shaping and how the beam propagates in the Y-Z and X-Z planes (the kerf is along the X-axis direction);

FIG. 3 is a schematic perspective view of how the beam is applied to the object of sawing process;

FIG. 4 is a schematic block diagram showing a beam shaping module and a beam focusing module, according to the invention;

FIG. 5 is a schematic diagram illustrating embodiments of a beam shaping module, according to the invention;

FIG. 6 is a schematic diagram illustrating embodiments of a beam focusing module, according to the invention;

FIG. 7 is a schematic diagram illustrating examples of beam profiles at several locations along the z-direction under different optical scenarios;

FIG. 8 is a schematic block diagram of one embodiment of a laser system, according to the invention, with various options to generate a desired beam with characteristics for laser sawing process where the desired beam properties can be achieved via intra-cavity or extra-cavity means;

FIG. 9 is a schematic diagram of one embodiment of a polarization splitting and recombining system, according to the invention;

FIG. 10 is a schematic diagram illustrating the use of multiple laser beams that can be from the same or different lasers, FIG. 10(a) illustrates a pulse train, FIG. 10(b) illustrates the multiple beams shown in the X-Z plane, and FIG. 10(c) illustrates the same beams shown in the Y-Z plane; and

FIG. 11 is a table that displays examples of several configurations with laser and optical parameters where configurations A and B are typical parameters used in conventional cutting systems and configurations C, D, and E are examples of the present invention.

### DESCRIPTION OF THE INVENTION

Diamond sawing yield can be viewed and analyzed in two categories: breakage and weight loss. Although these two categories may appear to be independent of each other, they are all related to the same laser process and can often be optimized or improved at the same time. The causes of breakage are complex and are due, at least in part, to not only the purity, stress, and the uniformity of the diamond, but also to laser beam optical characteristics, such as power, energy and pulse duration. There are common process conditions and parameters that can be studied and refined in order to reduce or eliminate the breakage problem. The cause of the weight loss is easier to understand. The weight loss is due mostly to the removal of material that allows the laser beam of a certain width to reach the required depth when sawing diamonds.

A laser-based diamond cutting and sawing system can include a laser with control and power electronics, laser beam delivery and focusing optics, light illumination and vision system(s), a diamond holding device, an X-Y table, a computer control module with user interface, and a workstation with enclosure. In some embodiments, additional or alternative equipment may be used.

One example of a diamond sawing process starts with a straight cut on the outer surface of a diamond. The width and depth of the cut are typically on the order of tens of micrometers. This thin cut is then duplicated sideways to make a wider cut and also moved deeper into the diamond as the top layers are removed by the laser. The cross-section profile of a sawing process is a V-shape, where the bottom of the V is the deepest point of the cut.

It is desirable to achieve the combination of the smallest beam diameter as well as the smallest beam divergence angle. This can produce the smallest diamond kerf width for the passage of the laser beam. A laser beam with the good focusability is ideal. Typically, a laser beam with M² of about ≦1.3 is used. This will typically result in the loss of only a relatively small amount of diamond, thereby achieving relatively low weight loss. As the laser beam quality is improved and or wavelength reduced, the beam diameter is also often reduced. This results, however, in an increase in the laser's peak power at the focal point and its depth of focus or Rayleigh length which consequently allows the laser to propagate longer distances at a very high peak power in the diamond after the focal point. This situation can increase the chance of breakage of the diamond due to, for example, the interaction with impurities and/or heat induced local stress build-up. Improvement can be often achieved if the sawing process produces a straight V-groove. Thanks to the practically unlimited clear opening aperture along the V-groove, the beam width in the direction of the kerf can be designed wider with larger divergence angle and allow faster defocus. As a result, the peak power and the effective laser-material interaction region are rapidly reduced after the focal point. This reduces the diamond breakage problem. The reduction of diamond breakage can be 10˜20 fold over the existing methods depending on the system parameters.

The present invention is directed to laser systems (particularly, laser systems for cutting and/or sawing) with unique laser design and/or unique beam shaping and focusing elements/methods. In at least some embodiments, these designs, elements, and methods can improve or optimize the properties of the laser beam used in cutting and sawing process. As a result reduced breakage and weight loss can be obtained in at least some embodiments. Methods and designs have been developed that can operate in the following situations: (1) intra-cavity of a laser, (2) extra-cavity of a laser, and (3) a combination of intra-cavity and extra-cavity of a laser.

The laser source used here can be any single laser, or a combination of lasers, producing laser beams in the infrared, visible (e.g., green), UV or even shorter wavelengths.

Although all cutting and sawing examples are shown here as single-sided processes, i.e., a laser beam applied only from one side of the diamond, the present invention can be practiced in double-sided cutting or sawing as well as other variations of applying a laser beam to a diamond.

For at least some embodiments, the method and apparatus disclosed in the present invention can provide an improved diamond sawing yield (e.g., less breakage, less weight loss, and/or improved throughput.) These methods and devices can apply to all forms and shapes of diamonds whether natural or synthetic and can be applied to other materials, particularly other transparent (e.g., transparent to the selected laser light) materials (including doped or undoped materials) such as, but not limited to, quartz, sapphire, glass, and semiconductors.

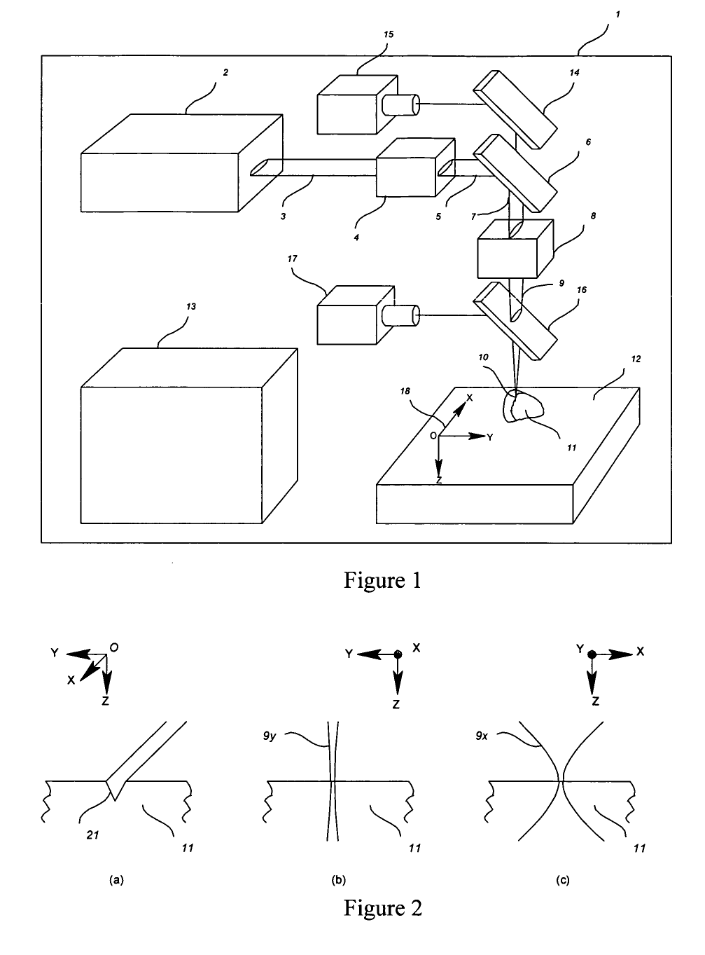

One embodiment of a laser based diamond sawing system 1 is illustrated in FIG. 1. A special laser beam is designed and generated. This beam is asymmetric in the two orthogonal planes, namely, the X-Z plane and the Y-Z plane. A Cartesian coordinate system 18 is used here for reference and clarification. The Z-axis is the direction of laser beam propagation. The X-Z plane is the plane of sawing and the Y-Z plane is perpendicular to the X-Z plane. This nomenclature will be used throughout this document unless specified otherwise.

A laser 2 generates a beam 3 that passes through a beam shaping module 4. Mirror 6 is optional, but useful, for bending the beam 5 into path 7 for sawing process. A beam focusing module 8 is shown followed by the focused beam 9 with its focal point 10 on a diamond 11 that is held on a X-Y table 12. The system control, a computer with user interface, and other auxiliary electronics are shown as reference numeral 13. A vision system (e.g., a system for observing and/or illuminating the diamond) and associated reflector are shown in two alternative locations 14, 15 or 16, 17. One may be more preferable than the other depending on the system designs and configurations.

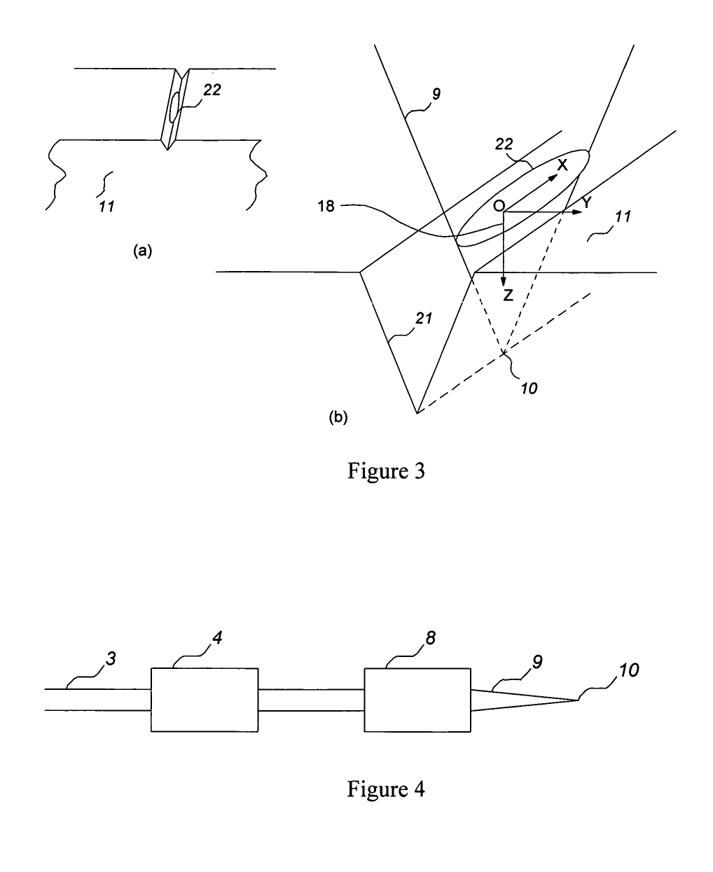

FIG. 2(a) indicates a diamond 11 with a small saw opening V-groove 21 extending in the direction of the X-axis. FIG. 2(b) shows the ray tracing profile 9y of the laser beam in the Y-Z plane when focused on the diamond whereas FIG. 2(c) shows the ray tracing profile 9x of the same laser beam in the X-Z plane. As illustrated here, the shape and focusing of the laser beam in the Y-Z plane is chosen to provide a relatively small beam width and a relatively small divergence to reduce or minimize weight loss. The shape and focusing of the laser beam in the X-Z plane on the other hand is chosen to have a substantially larger divergence angle to reduce the depth of focus and reduce or minimize the interaction length of the high peak power within the diamond after the focal point. The waist size of the laser beam in the X-Z plane can depend strongly on laser power, energy, pulse width, peak power, and M². FIG. 3 is a further illustration of a focused beam 9 with an elliptical spatial beam profile 22 aligned along the V-groove 21 with the focal point 10 at the bottom of the V-groove. The divergence angles in the X-Z plane can be significantly larger than that in the Y-Z plane, for example, a factor of at least 1.5, 2, 10, 20, 50, or 100 times larger or more.

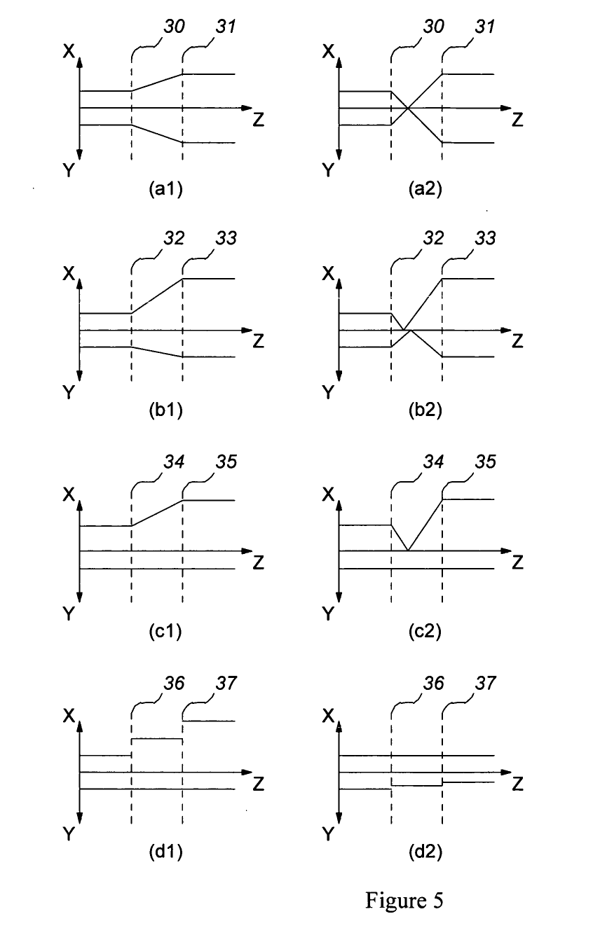

The desired beam propagation profile near focus is shown in FIG. 2 and there are a number of ways to achieve this profile. FIG. 4 illustrates a portion of the post-laser optics that includes a beam shaping module 4 and a beam focusing module 8 with the focused beam 9 and its focal point 10. One or both of the beam focusing module and the beam shaping module can be used to shape the beam to the desired profile. FIG. 5 provides several examples of beam shaping modules, although it will be understood that other beam shaping module configurations can also be used. For example, a beam shaping module 4 may include (1) a spherical beam expander with the input and output lenses designated as 30 and 31, respectively (FIGS. 5(a1), and 5(a2)); (2) a cylindrical beam expander with the input and output lenses designated as 34 and 35, respectively (FIGS. 5(c1), and 5(c2)); (3) an anamorphic beam expander with the input and output prisms designated as 36 and 37, respectively; (FIGS. 5(d1), and 5(d2)); or (4) a combination of the above mentioned (1), (2) and (3). FIGS. 5(b1) and 5(b2) show an alternative use of spherical lenses to achieve asymmetrical beam expansion when the lenses are tilted with laser incidence angles greater than 0 degrees. Astigmatism from the tilted lenses can result different effective focal lengths in X- or Y-directions. Therefore, a spherical lens can behave like a spherical/cylindrical lens combination.

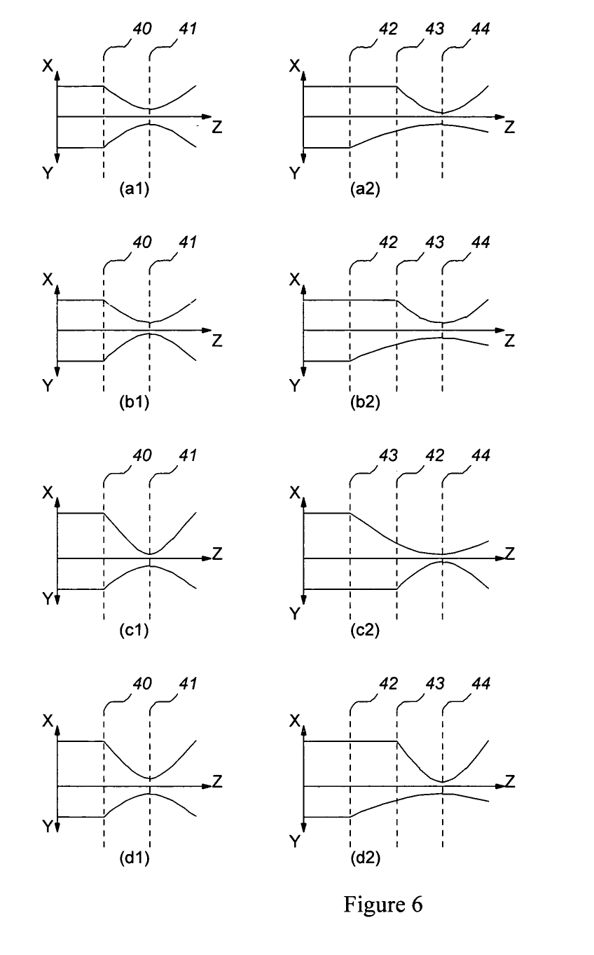

FIG. 6 provides several examples of beam focusing modules, although it will be understood that other beam focusing module configurations can also be used. For example, a beam focusing module 8 can include (1) spherical optics with an effective lens 40 and focal point 41 (FIGS. 6(a1), 6(b1), 6(c1), and 6(d1)); (2) cylindrical optics with the effective focusing elements in the X- and Y-direction designated as 43 and 42 and focal point 44, respectively (FIGS. 6(a2), 6(b2), 6(c2), and 6(d2)); or (3) any combination of the above (1) and (2).

Beam shaping module 4 and/or beam focusing module 8 can be motorized and automated in a laser system 1, if desired. For example, automation can change or alter the beam shape and/or beam focal point during the laser sawing process.

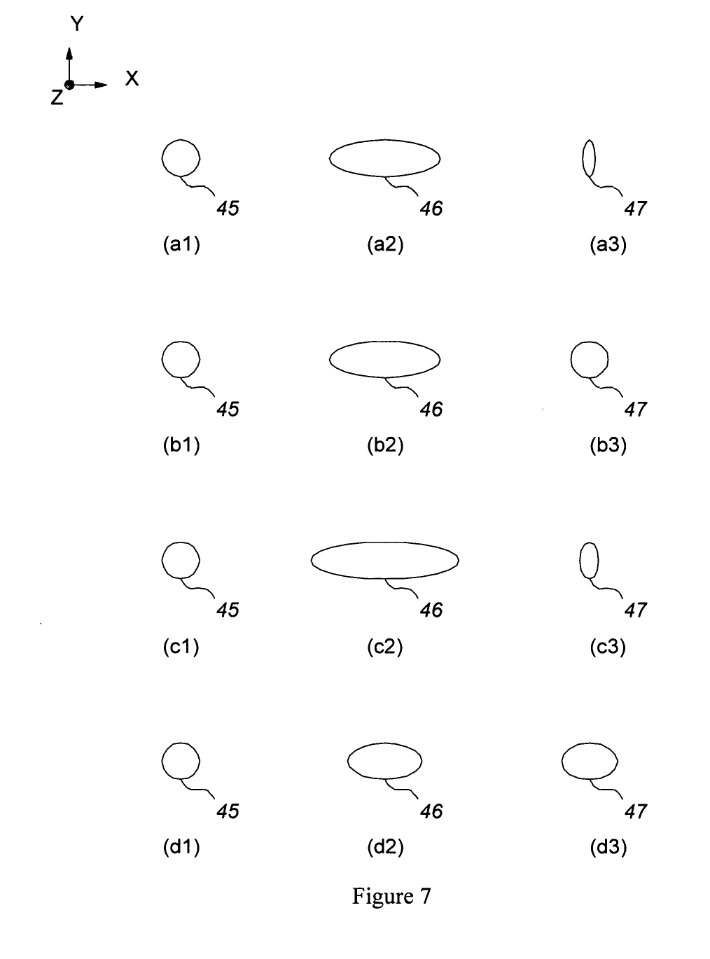

In at least one embodiment, the laser 2 used in the apparatus has an output spatial beam profile of a TEM₀₀, which preferably possesses a M² of 1. Many conventional lasers have a symmetric spatial beam profile. However, in some embodiments an application specific laser may instead have an asymmetric spatial profile (e.g., an asymmetric M², i.e., Mₓ²>>M_{y}²), namely a hybrid spatial mode. FIG. 7 shows examples of spatial beam profiles under various beam property scenarios. Laser beam spatial profile 45 at the location of laser output is shaped by a beam shaping module 4 with a spatial mode 46 at its output. It is intentionally elliptical-shaped and elongated on the X-axis. The spatial profile at the focal point is shown as 47, which is determined by parameters such as laser power, pulse energy, pulse duration, repetition rate, Mₓ², M_{y}², diamond geometry, and so on. FIGS. 7(a1)-7(a3) display one embodiment of the beam profiles of a laser that generates a symmetric TEM₀₀ beam. The beam profile is elliptical and elongated on the X-axis after the beam shaping module. As a result, the focal spot is elliptical, but elongated on the Y-axis.

Shown in FIGS. 7(b1)-7(d3) are possible beam profiles from a laser with hybrid output mode. The beam size at the focus can be adjusted to be (1) round, (2) elliptical and elongated on X-axis or (3) elliptical and elongated on Y-axis. For a laser that produces sufficient power to achieve a desired throughput rate, a round focal spot is good for sawing. For a laser that is underpowered (i.e., the laser does not produce the desired throughput rate when the focal spot is round), an elliptical focal spot elongated in Y-axis is typically better. Due to a smaller focal spot area, peak power and density will typically be higher than those in a circular spot. Thus it will provide additional peak power and density for the sawing process. For a laser that is overpowered, an elliptical focal spot elongated on X-axis is ideal, which may result in a higher sawing speed.

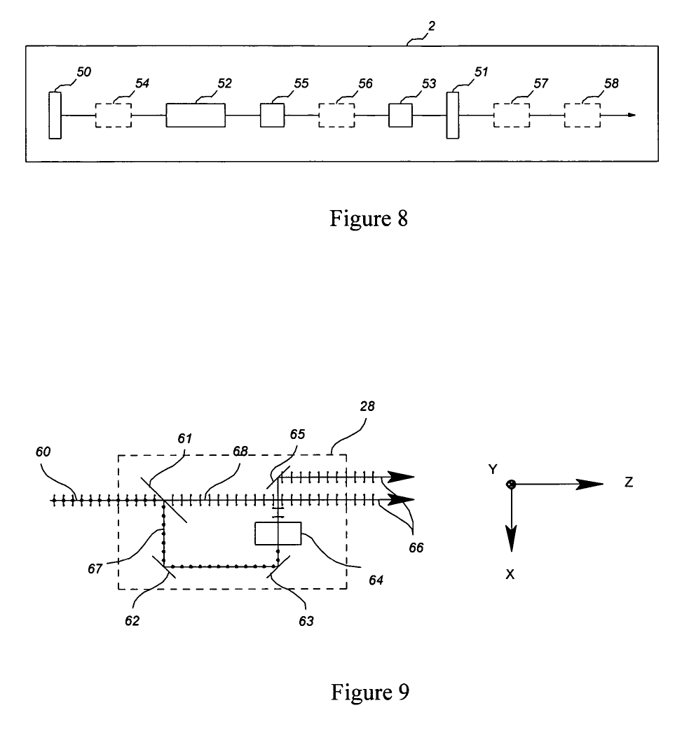

Direct generation of desired spatial mode characteristics can be beneficial to the sawing process and can be used in addition to beam shaping or as an alternative to beam shaping. Lasers commonly used in diamond sawing process are TEM₀₀ with round spot shape and axial symmetry. The generation of such beams is due, at least in part, to the fact that nearly all laser cavities have this axial symmetry by default. However, this may not provide the best mode for sawing applications. A special mode, such as a hybrid of low-order or multi-mode on the X-axis and TEM₀₀ on the Y-axis may result in 1) lower weight loss, 2) lower chance of cracking, and 3) higher sawing throughput. An example of the design of such a laser cavity 2 is shown in FIG. 8. For the purpose of illustration, a linear cavity is shown. However, a folded or ring cavity can also be used. It will be understood that this laser cavity can be used in conjunction with, or instead of, the beam shaping module and/or beam focusing module.

Mirrors 50 and 51 are the high reflector and the output coupler of the cavity, respectively. The laser gain medium 52 can be any known gain material, such as, but not limited to, Nd:YAG, Nd:YLF, Nd:YVO₄, Ti:sapphire, semiconductor(s), etc. Optionally, this gain medium 52 can be optically and/or electrically excited to generate the desired laser output power. An intra-cavity beam shaping module is shown as 53. Beam shaping can be done using a number of different methods and arrangements, such as, apertures of desired shapes (for example, round, elliptical or slit), and/or cylindrical optics (for example, lenses or mirrors). A polarization module 54 provides either linearly polarized or unpolarized laser output. It may also serve as a depolarization compensation mechanism in the cavity. An acousto-optic Q-switch 55 can be used to generate pulsed laser output. However, it will be recognized that pulsing can be generated actively (electro-optic) and/or passively (saturable absorber, dye, semiconductors, glass, etc.) using other elements. An optional intra-cavity harmonic generation module 56 is shown. In addition to the fundamental wavelength, with the utilization of module 56, the laser output can be at the second harmonic, third harmonic or even higher harmonic wavelengths. The benefit of such shorter wavelengths is to offer further reduced weight loss. An alternative method of generating harmonic wavelengths includes utilizing an extra-cavity harmonic generation module 57, which converts a fundamental output wavelength and/or its harmonics to higher harmonic wavelengths. The laser device 2 can also include an optional extra-cavity module 58 for polarization splitting and recombining. This allows the laser to generate unpolarized output at much greater power levels that could result in higher sawing throughput.

Shown in FIG. 9 is a schematic diagram of an extra-cavity polarization module 58. Input beam 60 is unpolarized (and shown with S and P polarizations.) A polarizer 61 reflects the S polarization 67 and transmits the P polarization 68. A waveplate 64 is used to rotate the S-polarization into the P-polarization. The two beams are then recombined by mirror 65 after steering mirrors 62 and 63. The final output of 58 includes two beams that are parallel and closely spaced. The beams are displaced with respect to each other on the X-axis only, so that they are preferably aligned to the length of the V-groove in diamond sawing process. The separation of the two beams is not critical but is ideally, in at least some embodiments, approximately 4ω to 5ω, where ω is the Gaussian beam radius. The polarization rotation step can take place before or after the beam recombining process. FIG. 9 displays an example using 64 before the recombining process.

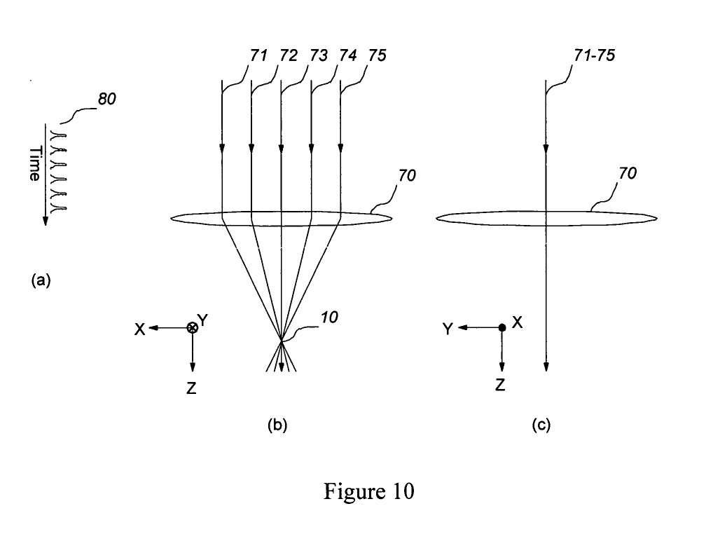

FIG. 10 shows an example of the practice of the present invention with multiple laser beams that are either from the same or different lasers with the same or different wavelengths. In at least some embodiments, lasers 2 have pulsed outputs. Each output produces a train of laser pulses 80 shown in FIG. 10(a). Five beams/pulse trains are shown in this example in FIG. 10(b) as 71, 72, 73, 74, and 75, focused by a lens 70. It will be recognized that any number of beams/pulse trains can be combined. Pulse trains can be combined in a variety of ways. For example, two or more pulse trains can be synchronous and in-phase (no temporal delay between each other). This can produce a combined laser beam with higher peak power. Two or more pulse trains can have the same pulse frequency but with a temporal delay (for example a delay of about 10-100 ns.) This can produce a combined laser beam with adjustable effective pulse durations. Two or more pulse trains can have the same pulse frequency but with a large temporal delay (for example a delay of about 50% of the pulse frequency period.) This can provide a combined laser beam with a higher pulse frequency. Two or more pulse trains can be provided with different wavelengths. This can be particularly useful in situations where a two-step cutting process is more efficient, for example, where a chemical bond can be excited to a higher energy state by the first laser and then cleaved by the second laser. These two pulse trains can be provided with the same or different pulse frequencies and simultaneously or sequentially (i.e., with a timing offset for the second laser relative to the first laser.) Two or more pulse trains can be provided with different pulse repetition rates (i.e., different pulse frequencies). It will be recognized that any set of these conditions can be applied to any combination of two or more pulse trains. For example, a combination of five pulse trains may include two pulse trains that are synchronized with each other, a third pulse train that has a delay, a fourth pulse train that has a different wavelength, and a fifth pulse train that has a different pulse repetition rate than the other four.

FIG. 10(b) is a view in the X-Z plane, where multiple beams with typical M²≧1 are parallel to each other. FIG. 10(c) is a view in the Y-Z plane where all beams typically have M²≦1.3 and are overlapped.

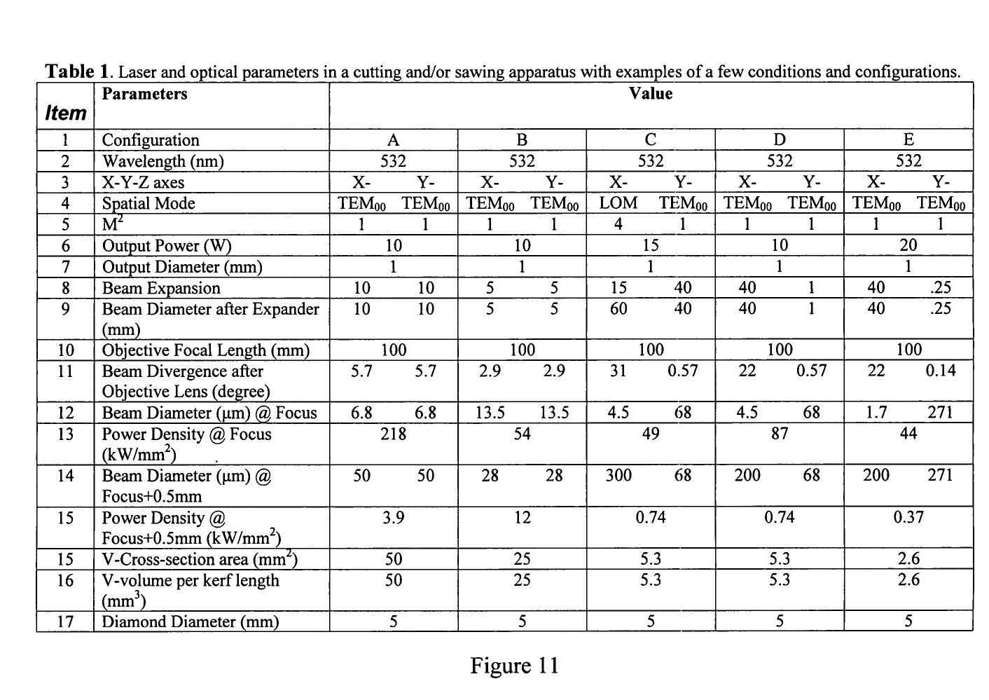

A detailed example of laser and optical parameters in a diamond cutting/sawing system is shown in FIG. 11. For simplicity, a wavelength of 532 nm is used here. The power densities at the focus and at a location 0.5 mm after the focus are listed as items 13 and 15, respectively in this table. Estimated V-groove volume is listed as item 16 for a diamond of approximately 5 mm in diameter. Configurations A and B list parameters that are used in a conventional cutting/sawing system. As comparisons, parameters of an apparatus designed according to the present invention are shown in Configurations C, D and E. Configuration C utilizes a special laser that generates a laser output with hybrid mode of LOM (low order mode) and TEM₀₀. Configuration D utilizes a regular laser with symmetrical output but cylindrical optical component in beam shaping module 4. As a result, power densities in Configurations C and D are significantly lower at locations 0.5 mm after focus. This leads to great reduction in diamond breakage. At the same time, it is quite evident that the V-groove volume in Configurations C and D are greatly reduced when compared to the conventional systems. The improvement for both breakage and weight loss can be at least a factor of 10. Configuration E displays a better-optimized set of parameters with a more powerful laser. Due to the increased power, pulse energy, and peak power, it is possible to have an even bigger focal spot diameter in the Y-axis direction and smaller beam divergence. This allows the minimum weight loss to be achieved, which is about 20 times less than from a conventional cutting/sawing system.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A laser cutting system, comprising:
a laser configured and arranged to produce a laser beam; and
a beam modifying module disposed to receive the laser beam and generate a modified laser beam at a focal point, wherein the modified laser beam has substantially larger divergence in a first direction than in a second orthogonal direction.

2. The laser cutting system of claim 1, wherein the beam modifying module comprises both a beam shaping module and a beam focusing module.

3. The laser cutting system of claim 1, wherein the laser system comprises a beam shaping module and the beam shaping module comprises a spherical beam expander, a cylindrical beam expander, an anamorphic beam expander, or a combination thereof.

4. The laser cutting system of claim 3, wherein the beam shaping module expands the laser beam in the first direction more than in the second orthogonal direction.

5. The laser cutting system of claim 1, wherein the laser system comprises a beam focusing module and the beam focusing module comprises spherical optics, cylindrical optics, or a combination thereof.

6. The laser cutting system of claim 1, wherein a divergence angle in the first direction is at least a factor of 1.5 larger than a divergence angle in the second orthogonal angle.

7. The laser cutting system of claim 1, wherein the divergence angle in the first direction is at least a factor of 10 larger than a divergence angle in the second orthogonal angle.

8. A laser cutting system, comprising:
a laser cavity configured and arranged to produce a laser beam with a TEM₀₀ beam profile along a first direction and a low-order or multi-mode profile along a second orthogonal direction.

9. The laser cutting system of claim 8, wherein the laser cavity comprises a beam shaping module.

10. The laser cutting system of claim 9, wherein the beam shaping module comprises an aperture.

11. The laser cutting system of claim 9, wherein the beam shaping module comprises a cylindrical optic module.

12. The laser cutting system of claim 8, further comprising an extra-cavity polarization module configured and arranged to separate the laser beam into first and second polarized beams, to alter the polarization of the second polarized beam and to combine the first and second polarized beams with the second polarized beam parallel and spatially displaced from the first polarized beam to provide a cutting beam.

13. A method of cutting an object using a laser, the method comprising:
generating a laser beam; and
directing the laser beam onto the object, wherein, at a site of cutting, the laser beam has substantially larger divergence in a first direction than in a second orthogonal direction.

14. The method of claim 13, wherein generating a laser beam comprises modifying a laser beam using a beam shaping module, a beam focusing module or both to provide with laser beam with substantially larger divergence in a first direction than in a second orthogonal direction.

15. The method of claim 13, wherein the first direction is parallel to a plane of cutting and the second orthogonal direction is orthogonal to the plane of cutting.

16. The method of claim 13, wherein, near the site of cutting, the laser beam has an asymmetric spatial profile.

17. A method of cutting an object using a laser, the method comprising:
generating a laser beam in a laser cavity, wherein the laser beam has a TEM₀₀ beam profile along a first direction and a low-order or multi-mode profile along a second orthogonal direction; and
directing the laser beam onto the object.

18. The method of claim 17, wherein directing the laser beam comprises separating the laser beam into a first polarized beam and a second polarized beam; altering the polarization of the second polarized beam; and combining the first and second polarized beams with the second polarized beam parallel and spatially displaced from the first polarized beam to provide a cutting beam.

19. The method of claim 17, wherein directing the laser beam comprises directing two pulsed laser beams at the object wherein the pulsed laser beams have a same pulse frequency and a different temporal delay.

20. The method of claim 17, wherein directing the laser beam comprises directing two pulsed laser beams with different wavelengths at the object.

21. The method of claim 17, wherein directing the laser beam comprises directing two pulsed laser beams with different pulse frequencies at the object.
